(19) United States
(12) Patent Application Publication
(10) Pub. No.: US 2008/0059397 A1
(43) Pub. Date: Mar. 6, 2008

(54) Systems and methods providing data warehousing capability to SQR

(75) Inventor: David John Ballesty, Blowing Rock, NC (US)

Correspondence Address: DAVID J. BALLESTY, P.O. BOX 1965, BLOWING ROCK, NC, 28605, US

(73) Assignee: SQRIntegrator, LLC.

(21) Appl. No.: 11/879,337

(22) Filed: Jul. 17, 2007

Related U.S. Application Data
(60) Provisional application No. 60/841,577, filed on Sep. 1, 2006.

(51) Int. Cl. G06F 17/30

(52) U.S. Cl. 707/1; 707/E17.045

(57) ABSTRACT

An advantageous system and method are provided for supporting and/or enabling the creation of Data Warehouse Scripts and/or data transfer in connection with a SQR-based application or program. The disclosed system and method offer a full complement of data warehousing and data transfer capabilities. In addition, the system and method of the present disclosure may be used in conjunction with and/or incorporated as part of an Enterprise Resource Planning or Business Intelligence platform on stand-alone clients and/or networked clients. The disclosed system and method generally include a object based mapping technology that captures both business rules and metadata, a database in communication with the mapping client, and creation formula that allows multiple levels of selection, subselection, transformation, and database actions that functions to control retrieval of data from the database, transformation of that data, and reinsertion to another or same target database.

### BACKGROUND

1. Technical Field

The present disclosure relates to a system and method for creating SQR programs with multiple sub-selects and database actions in the data warehouse or data transfer environments. The system and method of the present disclosure may be used in conjunction with and/or incorporated as part of SQR server installations found on stand-alone clients and/or networked clients and/or Servers. This system is called SALT, or Select Action Level Technology. This refers to the Select of Data, the Action against a database, the Level at what it happens.

2. Background of the Disclosure

The use of SQR for data warehousing, ETL, data transfer and data interface is pervasive. Conventional companies and governments use SQR to manually code scripts to transfer data in multiple formats and scenarios. Manually or partially manually written SQR programs are used by both software companies and their clients to create conversions, etl processes, batch processes, and both inbound and outbound interfaces

Both software companies and their client companies use SQR conversion programs to transfer all or part of the data resident in legacy or less desirable enterprise applications. This process uses SQR programs to obtain the information in the old application, possibly do some transformation of the data, and insert it into the new enterprise application.

Both software companies and their client companies use manually or partially manually coded SQR ETL programs to transfer all or part of the data from multiple internal and external systems to create a single or multiple data warehouse(s) and data mart(s). This process uses SQR programs to obtain the information in the multiple internal and external systems, possibly do some transformation of the data, and insert it into the new data warehouse(s) and data mart(s). This transfer process happens on a regularly scheduled basis. The new data warehouse(s) and data mart(s) are then used for reporting purposes.

Both software companies and their client companies use manually or partially manually coded SQR batch process programs to batch process all or part of the data from multiple systems to create aggregated data for those systems. This process uses SQR programs to obtain the information in the application, possibly do some transformation of the data, such as gross to net, eligibility, or payment calculations and re-insert it into the system. This batch process happens on a regularly scheduled basis.

Both software companies and their client companies use manually or partially manually coded SQR interface programs to process all or part of the data from multiple systems to create inbound or outbound data interfaces. This process uses SQR programs to obtain the information in the application, possibly do some transformation of the data, such as gross to net, eligibility, or payment calculations and create an outbound interface to some other application or business partner. It may also take inbound interface information, process it, and insert the information into the client system. This interface process happens on a regularly scheduled basis.

### SUMMARY OF THE DISCLOSURE

According to the present disclosure, an advantageous system and method are provided for creating and managing the automated creation of SQR programs multiple levels of sub-selection and database actions. The disclosed system and method offer the full range of levels of joining data and database actions. In addition, the system and method of the present disclosure may be used in conjunction with and/or incorporated as part of a wide range of not only data warehouse applications, but also as part of the many SQR enabled enterprise resource planning systems such as payroll, human resources, accounts payable, accounts receivable, and asset management systems on both servers, networked and stand-alone systems. The systems and methods are contained in a new product called SQRIntegrator, a data warehouse solution.

In a preferred embodiment of the present disclosure, the disclosed system and methods are advantageously incorporated into a data warehousing solution connected to an SQR enabled system such as Hyperion Solutions Foundation (Santa Clara, Calif. 95054), PeopleSoft (now Oracle) HR/Payroll (Redwood Shores Calif., 94065), or similar ADP payroll system (Roseland, N.J.).

Exemplary systems and methods according to the present disclosure further include functionalities for: referring to the main join of an SQR data warehouse mapping. Once the main join commerce object has been referred to by another join, the SQR data warehouse mapping can then allow recursive referral of multiple other join commerce objects, both at the level of the current join commerce object, and below the current join commerce object. The recursive referrals may go as far as 10 levels deep, and a large number of join commerce objects may happen at each level.

The disclosed systems and methods are advantageously adapted to associate database actions (the dbstrat commerce object and it's associated join and level criteria) with the recursive join commerce objects, allowing for the generation of SQR programs to insert, update and delete information to the target database table(s).

Once the join has been associated to the main join commerce object, and the database action commerce objects have been associated with the join commerce objects and their associated levels of recursion, the disclosed system then has a system to interpolate the placement of those commerce objects to create optimized SQR code for data warehousing, ETL, batch processes and interfaces.

Additional features, functions and benefits associated with the disclosed system and methods will become apparent from the detailed description which follows, and the claims appended hereto.

### BRIEF DESCRIPTION OF THE DRAWINGS

So that those having ordinary skill in the art to which the disclosed system and method pertains will more readily understand how to employ and use the same, reference may be made to the drawings wherein:

FIG. 1 is an exemplary screen display illustrating what a standard data warehouse commerce object inside of a mapping looks like in SQRIntegrator. In this case, the JOIN commerce object, or one of the containers of the disclosed system and method is boxed in red.

FIG. 2 is an exemplary screen display illustrating what a standard data warehouse commerce object inside of a mapping looks like in SQRIntegrator. In this case, the DBSTRAT commerce object, or one of the containers of the disclosed system and method is boxed in red.

FIG. 3 is an exemplary screen display illustrating what a the inside of the Join Criteria Detail Panel looks like in SQRIntegrator. The two drop downs show where the selection of “select join level” and “select parent join” are made.

FIG. 4 is an exemplary screen display illustrating what a the inside of the Data Strategy Detail Panel looks like in SQRIntegrator. The two drop downs show where the selection of “select join level” and “select parent join” are made.

FIG. 5 is an exemplary diagram of Selection Action Level Technology Visualization

FIG. 6 is an exemplary diagram of Creation Flow Showing Creation of SQR code using SALT

### DETAILED DESCRIPTION OF PREFERRED EMBODIMENT(S)

The present disclosure provides an advantageous system and method creating SQR programs used in data warehousing, ETL (extract, translate, load), batch processes, and interfaces. The disclosed system and method offer a full ability to create optimized SQR code in generally accepted best practice, along with the ability to create sub-selects and database actions down to nine levels deep. In addition, the system and method of the present disclosure may be used in conjunction with and/or incorporated as part of an end to end business intelligence system, such as one provided by Hyperion Solutions Corporation (Santa Clara, Calif. 95054).

In a preferred embodiment of the present disclosure, the system and method are incorporated into the technology stack of a business intelligence solution such as Hyperion Solutions Foundation product.

The following patents offer a wide range of patents granted that mention the use of SQR in some way for either reporting, conversion, data transfer, or interface

| | | |
|---|---|---|
| 7,003,560 | Feb. 21, 2006 | Mullen, et al. |
| 7,003,489 | Feb. 21, 2006 | Dixon, III, et al. |
| 6,850,908 | Feb. 1, 2005 | Smith, II, et al. |
| 6,850,643 | Feb. 1, 2005 | Smith, II, et al. |
| 6,832,263 | Dec. 14, 2004 | Polizzi, et al. |
| 6,718,338 | Mar. 30, 2004 | Bowman-Amuah |

For the purposes of explaining the following, an SQR mapping is a mapping made up of Commerce Objects. The mapping in the whole is what is used to contain business logic to create and maintain an SQR process.

Generally, it has been found according to the disclosed system and method that the creation of SQR programs created for data warehousing, ETL, conversion, batch processes or interfaces (generally referred to herein as “SQR processes”) may be supported, enabled and/or implemented through the use of Select Action Level Technology (hereafter referred to as “SALT”).

For the purposes of explaining in detail, an SQR mapping is a visual based mapping made up of Commerce Objects. Commerce Objects are individual, visual based objects that contain discrete elements of business logic, and they combine with other Commerce Objects to make the whole. The mapping in the whole is what is used to contain business logic to create and maintain an SQR process.

An advantageous method is disclosed herein which, when executed, automatically creates SQR programs by setting table selection levels and database action levels. These settings, in general, are contained in the JOIN and DBSTRAT commerce objects. The setting of these levels, and the algorithm that interpolates the settings inside of the SQR mapping, resulting in the SQR process, comprise the SALT.

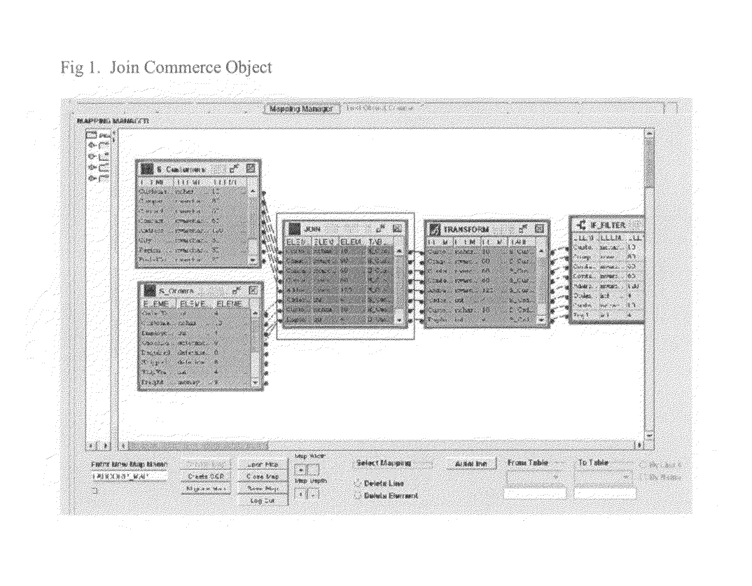

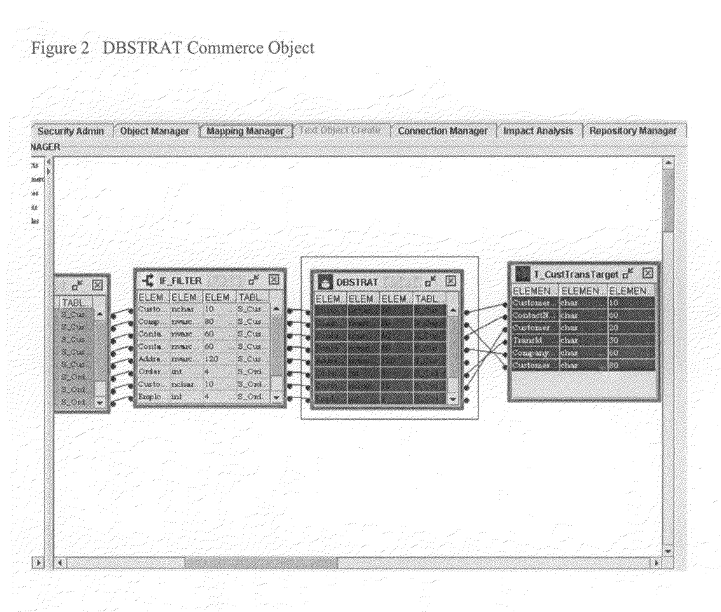

A JOIN commerce object has the purpose of joining sources of information, generally relational tables. It is shown highlighted by red in FIG. 1. A DBSTRAT commerce object has the purpose of setting the database action to the target table it is connected to. It is shown highlighted by red in FIG. 2.

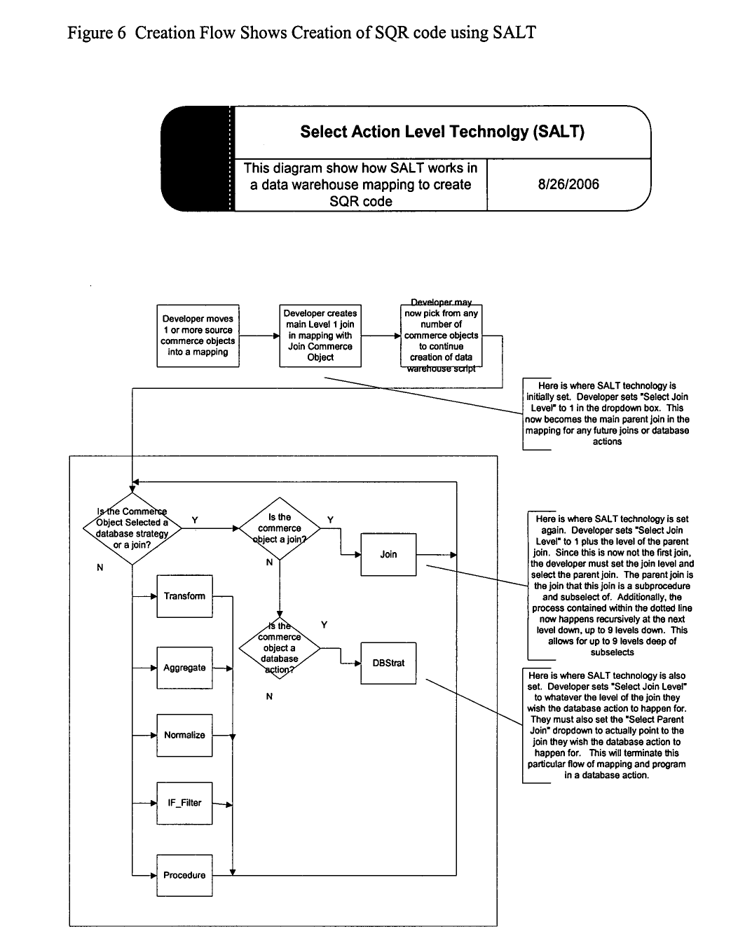

In an end-to-end business intelligence, it is common to create an SQR process. The method and process in this disclosure works in the following fashion. The flow of the following method and process disclosed is represented in a flow chart in FIG. 6 titled “Creation Flow Shows Creation of SQR code using SALT”

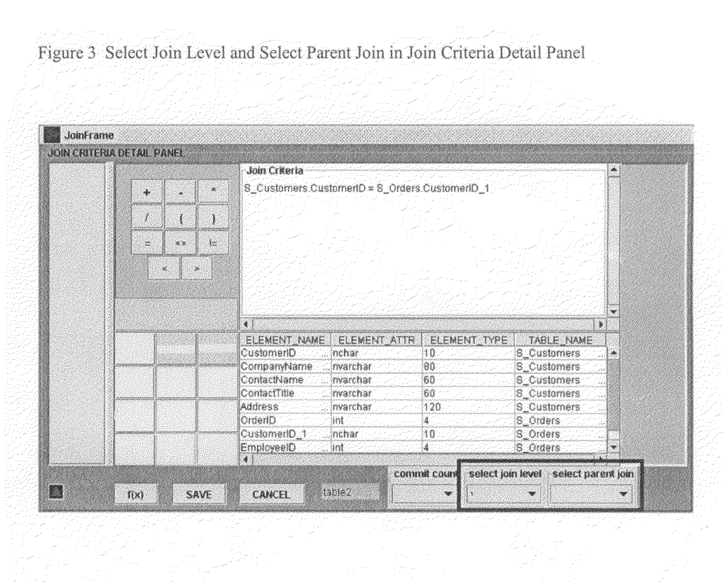

Sources or tables from a database are brought into the SQR mapping. The JOIN commerce object is then used to create a JOIN in the mapping, such as shown in FIG. 1. Business logic pertinent to that table join is then applied. Once these tables are joined, two settings must be set inside the commerce object. One is the “Select Join Level” and the other is “Select Parent Join”. Both are shown in FIG. 3. For the level 1 join, (the first join in the mapping) only the “Select Join Level” needs to be applied, since there are no other source joins at this time

There may then be a number of other commerce objects that are then brought into the SQR mapping for the purpose of applying other business rules, depending on the discrete commerce object. 3 possibilities can now happen.

The commerce object is not either a JOIN or DBSTRAT
The commerce object is a JOIN
The commerce object is a DBSTRAT

If the commerce object selected is not either a JOIN or DBSTRAT, SALT needs no further action by the user.

If the commerce object selected is a JOIN, this means it is a subjoin of a parent join, and the user will have to select the “Select Join Level” they wish the JOIN to occur in, usually the previous parent join level number plus 1. They will then have to select from the dropdown “Select Parent Join” to refer to the actual JOIN that is the parent of the subjoin now being in operation by the user. This is shown in FIG. 3. This process can happen as many times as needed at that JOIN level, and up to 9 levels of sub-join.

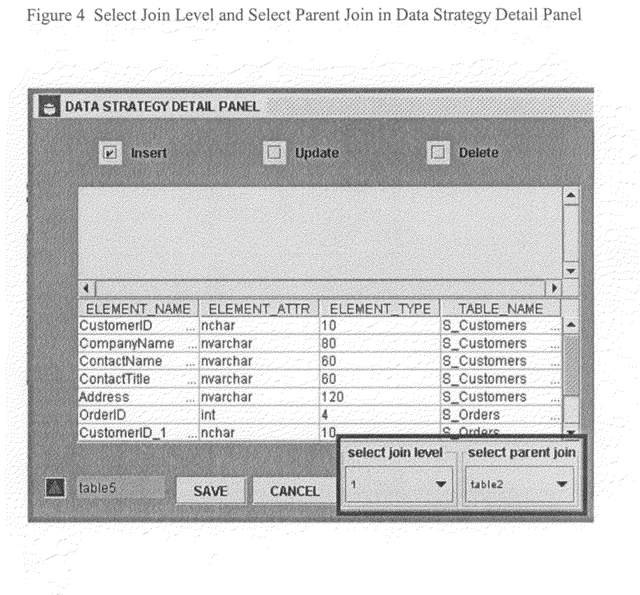

If the commerce object selected is a DBSTRAT, this means this flow of the mapping will terminate in a database action against a target (target being a table or flatfile). The user will have to select the “Select Join Level” of the parent join they wish the database action to occur in. They will then have to select from the dropdown “Select Parent Join” to refer to the actual JOIN that the database action is to occur in. This is shown in FIG. 4.

To make it clear, SALT is comprised of settings inside of the JOIN and DBSTRAT commerce objects, and the algorithm that is discussed in this disclosure below.

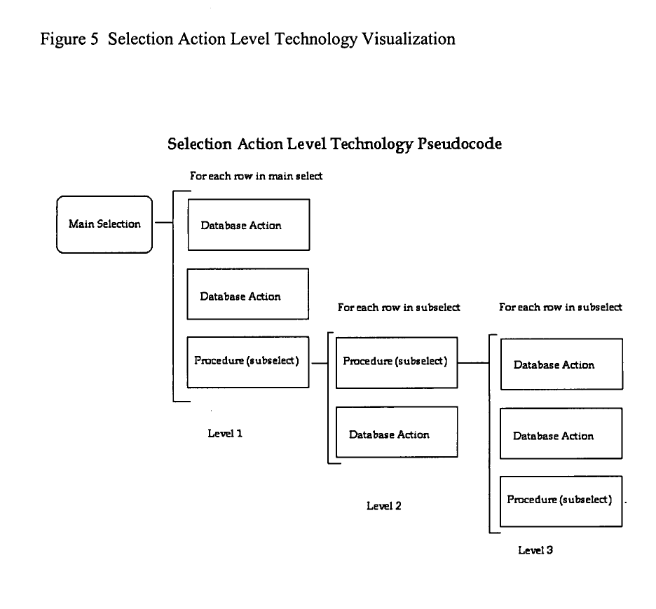

To further expand on and explain in detail the setting levels and parent joins in the JOIN and DBSTRAT commerce object that make up SALT and the SQR process generation, refer to FIG. 5 “Selection Action Level Technology Visualization”

The algorithm portion of the disclosed process and method (SALT) is triggered during the SQR process generation, or the creation of the SQR code for Data Warehousing, ETL, Conversion, Batch Process or Data Interface. The SALT algorithm first looks for the main join in a mapping. It then parses through all of the commerce objects in a mapping and does the following:

If there is a main join, create the initial join procedure in the SQR program. Create a loop that parses all of the commerce objects sequentially. ++If the object is not a JOIN or DBSTRAT commerce object, ignore it for the purposes of SALT (other processes not included in this disclosure happen). If the commerce object is a JOIN, and it points back to the initial parent JOIN and is 1 level deeper than the parent JOIN, create an SQR procedure that joins the subselect with data elements from the main join. If the commerce object is a DBSTRAT, and it points back to the initial parent JOIN and is at the level of the parent JOIN, create an SQR procedure that executes a database action to the connected target with data elements from the main join. +++The algorithm of the disclosed system iterates from the “++” symbol earlier in the paragraph to the “+++” symbol until either it reaches a 9^{th} level JOIN or the algorithm runs out of objects and levels to evaluate.

This algorithm pseudocode is contained in FIG. 6 titled “Creation Flow Shows Creation of SQR code using SALT”

What is claimed is:

1. A method for Creation of data warehousing scripts in the SQR language, comprising:
a) providing an system of assigning levels and parent objects to a visual commerce object that controls the joining of data from source(s) data object.
b) providing an system of assigning levels and parent objects to a visual commerce object that controls insert, update or delete actions of transformed data into a database;
c) providing a system of interpreting the two previous types of objects and their constituent settings to create SQR programs that are used in data warehousing and data transmission; d) providing a database in communication with said objects to store that information for later use.

2. A method according to claim 1, wherein said SQR program is supported by a SQR server that provides compilation and calculation functionalities to said SQR program.

3. A method according to claim 1, wherein said application is a collaborative data warehouse application that operates across a plurality of networked computers.

4. A method according to claim 1 a), wherein said commerce objects have the ability to refer to previously created joins for sub-selection.

5. A method according to claim 4, wherein said commerce objects have the ability to refer to what level of select or subselect the previously created joins reside at.

6. A method according to claim 1 b), wherein said commerce objects have the ability to refer to previously created joins for sub-selection.

7. A method according to claim 6, wherein said commerce objects have the ability to refer to what level of select or subselect the previously created joins reside at.

8. A method according to claim 1, wherein said commerce objects have the ability to be moved around independently in a data warehouse mapping, and be connected to other commerce objects not listed in claim 1.

9. A method according to claim 8, further comprising: e) The flow of metadata through the commerce objects allowing join of data, and the insert, update or delete of data by the generated SQR programs.

10. A method according to claim 1C, wherein a process exists that will interpolate the placement of the commerce objects in the mapping, and the settings of the “select parent join” and “select join level”, and their relationship to other commerce objects, to control the placement of the joining of data and the database action in the output SQR.
